(19) United States
(12) Patent Application Publication
(10) Pub. No.: US 2015/0117035 A1
(43) Pub. Date: Apr. 30, 2015

(54) Heat Sink for Chip Mounting Substrate and Method for Manufacturing the Same

(71) Applicant: Point Engineering Co., Ltd., Asan-si (KR)

(72) Inventors: Bum Mo Ahn, Yongin-si (KR); Seung Ho Park, Hwaseong-si (KR); Tae Hwan Song, Cheonan-si (KR)

(21) Appl. No.: 14/511,357

(22) Filed: Oct. 10, 2014

(30) Foreign Application Priority Data
Oct. 11, 2013 (KR) 10-2013-0121204

(51) Int. Cl. F21V 29/70; F21V 19/00

(52) U.S. Cl. CPC F21V 29/70; F21V 19/0015; F21V 19/005; F21Y 2101/02
USPC 362/373; 264/272.17

(57) ABSTRACT

Provided is a heat sink for a chip mounting substrate in which a heat dissipation material is embedded. The heat sink includes: an accommodation portion configured to accommodate a substrate whereon a chip is mounted or to be mounted, and support or fix the accommodated substrate; and a heat dissipation portion configured to insulate the accommodated substrate, and dissipate heat generated from the substrate or the chip mounted on the substrate to an outside through a heat dissipation material contained in the heat dissipation portion. Accordingly, since the heat sink for a chip mounting substrate in which a heat dissipation material is embedded is manufactured by injection molding, a manufacturing process can be simplified. Further, since the heat sink of a single structure is used, a TIM bonding layer for bonding the substrate and the heat sink is not required, and an electrical insulating layer formed by anodizing an upper surface of the heat sink for electrical insulation between the substrate and the heat sink is not required, and thus the structure can be simplified.

### BACKGROUND

1. Technical Field

The present invention relates to a heat sink for a chip mounting substrate and a method of manufacturing the same, and more particularly, to a heat sink for a chip mounting substrate in which a heat dissipation material is embedded.

2. Description of the Related Art

Generally, semiconductor light emitting diode (LED) receives attention from various fields as an environment friendly light source. Recently, as applications of LEDs are expanding to various fields such as interior and exterior illuminations, automobile headlights, and back-light units (BLU) of display devices, there are needs for high optical efficiency and excellent heat radiation characteristics. For high efficiency LEDs, materials or structures of the LEDs should be improved primarily, however there is a need for improvement in the structures of the LED packages and the materials used therein.

In such high efficiency LEDs, high temperature heat is produced, therefore this heat must be radiated effectively otherwise temperature rising on the LEDs causes ageing of the characteristics thereby shortening the lifetime. In high efficiency LED packages, efforts on effective radiation of the heat produced by the LEDs are making progress.

However, according to a conventional optical device, since there is a limitation on reducing the thickness of the thermal interface material (TIM) bonding layer for bonding a substrate on a heat sink which is formed of a material such as aluminum and the like in order to dissipate heat generated from an optical device such as an LED, the heat dissipation characteristics deteriorate due to the thickness even when an excellent heat dissipation material is used, productivity decreases since a process of precisely arranging the optical device on the heat sink is performed by hand, and also there is a problem in which uniform heat dissipation characteristics cannot be secured since an entire coated thickness or a portion of coated thickness of the TIM bonding layer differs according to skill of an operator.

Further, since a process of forming an electrical insulating layer by anodizing an upper surface of the heat sink for electrical insulation is required, there is a problem in that a working time and the number of workers are increased.

Moreover, the anodized insulating layer formed very thinly on the upper surface of the heat sink can be damaged since burrs are generated in the process of separating, that is, sawing or dicing each unit optical device manufactured from an original substrate for the optical device, and also there is a problem in that defects such as short circuits are generated since insulation between the substrate and the heat sink is destroyed.

### SUMMARY

The present invention is directed to a heat sink for a chip mounting substrate in which a heat dissipation material of a single structure is embedded, and a method of manufacturing the same.

In order to solve the above problems, an embodiment provides a heat sink for a chip mounting substrate, which contains a heat dissipation material, including: an accommodation portion configured to accommodate a substrate whereon a chip is mounted or to be mounted, and support or fix the accommodated substrate; and a heat dissipation portion configured to insulate the accommodated substrate, and dissipate heat generated from the substrate or the chip mounted on the substrate to an outside through a heat dissipation material contained in the heat dissipation portion.

It is preferable that the accommodation portion and the heat dissipation portion are formed by injecting an insulating material containing the heat dissipation material into a mold configured to provide a space for accommodating the substrate.

It is preferable that the accommodation portion includes: a supporting portion configured to fix at least one portion of an upper surface of the accommodated substrate; an accommodation portion wall surface configured to fix a side surface of the substrate; and an accommodation portion bottom surface configured to support and fix the substrate.

It is preferable that the heat sink is configured to preserve electrical insulative properties of an original substrate electrically isolated by an insulating layer in the substrate.

It is preferable that a ratio of the heat dissipation material contained in the heat sink is determined based on a thermal conductivity of the heat dissipation material and an electrical insulation so as to preserve electrical insulative properties of an original substrate electrically isolated by an insulating layer in the substrate.

In order to solve the above problems, an embodiment provides a method of manufacturing a heat sink for a chip mounting substrate containing a heat dissipation material, including: injecting an insulating material containing the heat dissipation material into a mold configured to provide a space for accommodating a substrate whereon a chip is mounted or to be mounted; and forming an accommodation portion and a heat dissipation portion by hardening and curing the injected insulating material, wherein an accommodation portion is configured to accommodate the substrate and support or fix the accommodated substrate, and a heat dissipation portion is configured to insulate the accommodated substrate and dissipate heat generated from the substrate or the chip mounted thereon to an outside through the heat dissipation material.

It is preferable that the mold includes a space for forming a supporting portion configured to fix at least one portion of an upper surface of the inserted or accommodated substrate, an accommodation portion wall surface configured to fix a side surface of the substrate, and an accommodation portion bottom surface configured to support and fix the substrate.

It is preferable that a ratio of the heat dissipation material contained in the heat sink is determined based on a thermal conductivity of the heat dissipation material and an electrical insulation so as to preserve electrical insulative properties of an original substrate electrically isolated by an insulating layer in the substrate.

Since the heat sink for the chip mounting substrate in which the heat dissipation material is embedded according to the present invention can be manufactured by injection molding, a manufacturing process can be simplified. Further, since the heat sink of a single structure is used, a TIM bonding layer for bonding the substrate and the heat sink is not required, and an electrical insulating layer formed by anodizing an upper surface of the heat sink for electrical insulation between the substrate and the heat sink is not required, and thus the structure can be simplified.

### BRIEF DESCRIPTION OF DRAWINGS

FIGS. 1a and 1b are plan views for describing the steps of manufacturing optical devices having different structures in an original substrate for different optical devices;

FIG. 2 is a cross-sectional view for describing a method of bonding a unit optical device to a heat sink according to the prior art;

FIG. 3 is a cross-sectional view illustrating a heat sink for a chip mounting substrate in which a heat dissipation material is embedded according to an embodiment of the present invention;

FIG. 4 is a cross-sectional view illustrating an example in which a substrate is disposed in a heat sink containing a heat dissipation material according to an embodiment of the present invention; and

FIG. 5 is a flowchart for describing a method of manufacturing a heat sink containing a heat dissipation material according to an embodiment of the present invention.

### DETAILED DESCRIPTION OF EMBODIMENTS

The following description is illustrative of the principles of the invention. Although not clearly described and not shown in this specification, those of ordinary skill in the art may implement principles of the present invention and invent various devices included in the scope and spirit of the present invention. Further, conditional terms and exemplary embodiments described in this specification are intended for the purpose of allowing the spirit of the present invention to be clearly understood, and it should be understood that the present invention is not limited to exemplary embodiments and states which are specifically described herein.

The above-described objects, features and advantages will be more apparent from the accompanying drawings and the following description, and those of ordinary skill in the art may embody and practice the spirit of the present invention.

Further, when it is determined that detailed description with respect to known technology related to the present invention unnecessarily obscures the gist of the present invention, detailed description thereof will be omitted. Hereinafter, exemplary embodiments of a heat sink for a chip mounting substrate in which a heat dissipation material of a single structure is embedded will be described in detail with reference to the accompanying drawings, and for convenience, an example in which the chip is a light emitting diode (LED) will be described.

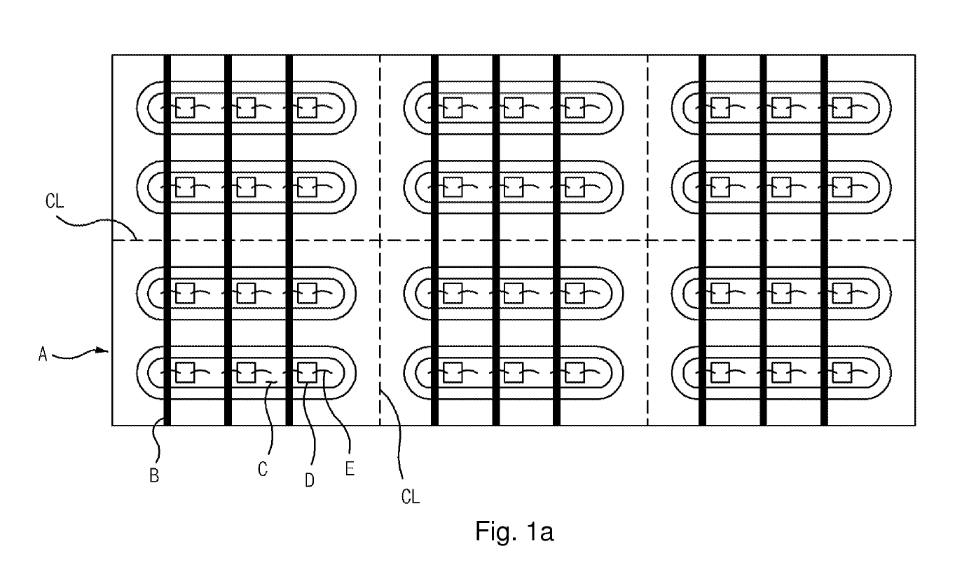

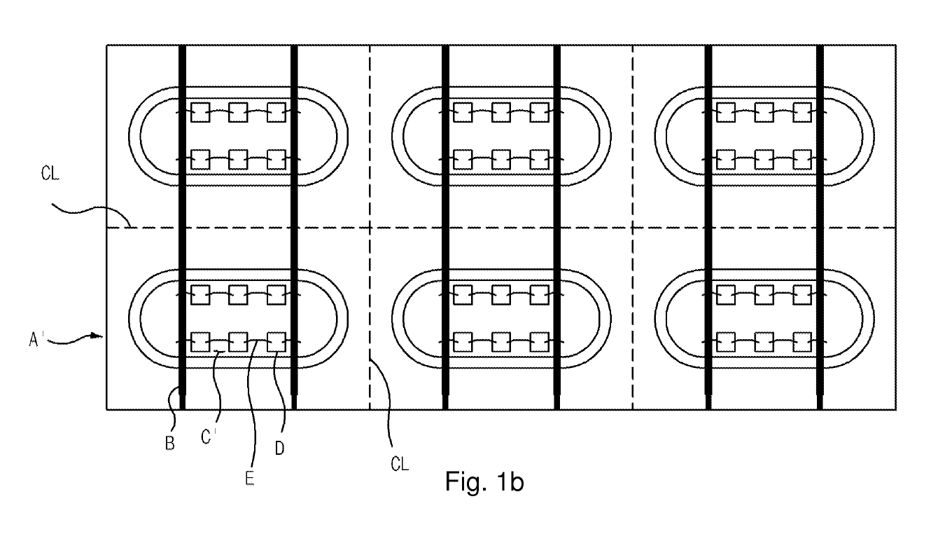

FIGS. 1a and 1b are plan views for describing the steps of manufacturing optical devices having different structures from the original substrates for different optical devices. As shown in FIG. 1a, in order to increase efficiency of work when manufacturing a conventional optical device, first, a cavity C having a groove of a shape which has a predetermined depth from an upper surface of an original substrate A having a plurality of vertical insulating layers B and has a wide upper portion and a narrow lower portion and having an embedded vertical insulating layer B is formed in an original substrate A, and after this, a wire E is bonded in a state in which an optical element D is disposed in each cavity C.

After this, the unit optical device may be finally manufactured by cutting the original substrate A for the optical device in vertical and horizontal directions along a cutting line CL, and after this, the cut unit optical device may be used by being bonded to the heat sink in order to dissipate heat quickly.

In FIG. 1a, a total of six optical devices in which three optical elements arranged in the horizontal direction and two optical elements arranged in the vertical direction are disposed in each optical device may be manufactured in the original substrate A for the optical device, and the optical elements arranged in the horizontal direction may be connected in series and the optical elements arranged in the vertical direction may be connected in parallel.

Next, the example of FIG. 1b is the same as the example FIG. 1a in that a total of six optical devices are manufactured from one original substrate A′ for the optical device, and three optical elements arranged in the horizontal direction and two optical elements arranged in the vertical direction are disposed in each optical device. However, all of the (total of six) optical devices may be disposed in one cavity C′, and also a wire E for serially connecting adjacent optical elements may have a structure which is directly bonded to the optical element D without passing through the substrate, unlike the example of FIG. 1a.

The structure described above is only an example, and optical devices having various structures may be manufactured from original substrates for various optical devices having various sizes and structures.

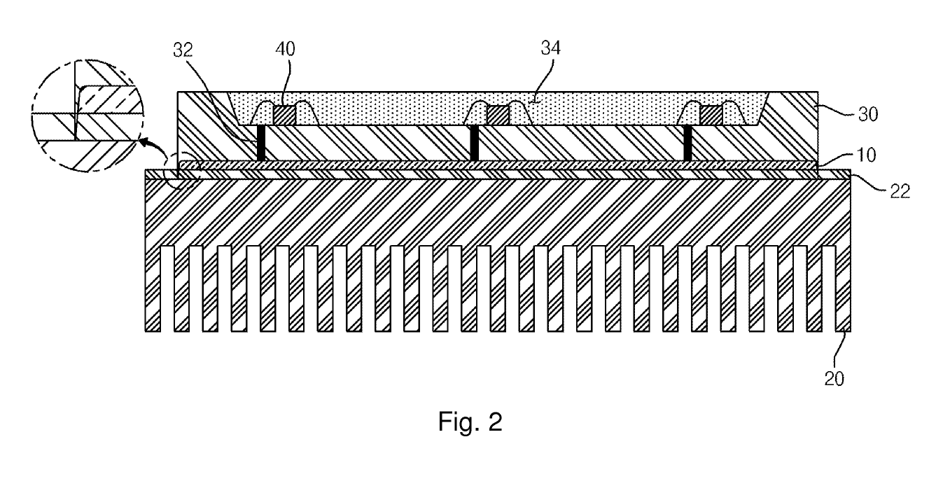

FIG. 2 is a cross-sectional view for describing a method of bonding a unit optical device manufactured as shown in FIG. 1a to a heat sink. As shown in FIG. 2, the substrate 30 may be bonded on the heat sink 20 which is formed of an aluminum material and the like in order to dissipate heat generated from the optical element 40 disposed in the cavity 34, and a material for bonding the substrate 30 to the heat sink 20 may be a TIM 10 such as a silicone oil and the like filled with aluminum oxide, zinc oxide, or boron nitride, and the like which has excellent heat dissipation characteristics. Further, an electrical insulating layer 22 may be formed by anodizing an upper surface of the heat sink in order to electrically insulate the substrate 30 and the heat sink 20.

According to the conventional optical device described above, since there is a limitation on reducing a thickness of the TIM bonding layer 10, there is a problem in that the heat dissipation characteristics deteriorate due to the thickness even when an excellent heat dissipation material is used, productivity decreases because a process of precisely arranging the optical device on the heat sink is performed by hand, and also there is a problem in that uniform heat dissipation characteristics cannot be secured because an entire coated thickness or a portion of coated thickness of the TIM bonding layer 10 differs according to skill of an operator. Further, since a process of forming an electrical insulating layer by anodizing the upper surface of the heat sink for the electrical insulation is required, there is a problem in that a working time and the number of workers are increased.

Moreover, in the unit optical device manufactured from the original substrate for the optical device shown in FIG. 1a, for example, the optical device separated on the far right of FIG. 1a, a burr may be generated on the far left in the separating process as shown in FIG. 2, that is, sawing or dicing. Therefore, the anodized insulating layer 22 formed very thinly on the upper surface of the heat sink 20 may be damaged, and the insulating layer between the substrate 30 and the heat sink 20 may be destroyed, thus generating a defect such as a short circuit.

In addition, when the optical device is disposed in a metal housing or is located adjacent to a metal component, a side portion of the optical device is exposed. Hence, there is a problem in that a creeping discharge is caused and voltage withstand capability is lost when a high voltage is applied due to a lightning from the outside, etc. Accordingly, it is necessary to insulate the side portion of the optical device from such an outside environment.

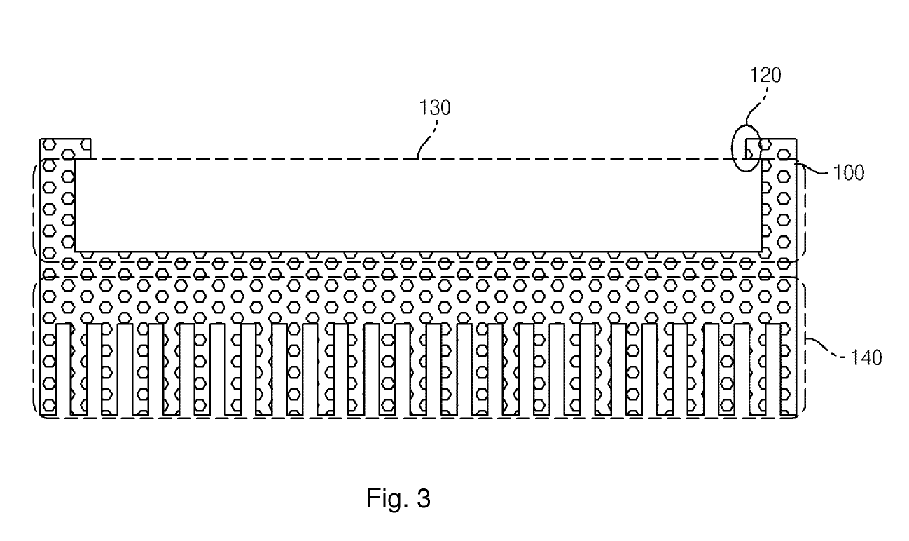

Hereinafter, referring to FIG. 3, a heat sink containing a heat dissipation material according to an embodiment of the present invention will be described.

Referring to FIG. 3, a heat sink 100 containing a heat dissipation material 110 may include an accommodation portion 130 and a heat dissipation portion 140. In this embodiment, the accommodation portion 130 and the heat dissipation portion 140 will be described as being separated, but it may be desirable to integrally form the accommodation portion 130 and the heat dissipation portion 140 as a single structure since the accommodation portion 130 and the heat dissipation portion 140 are manufactured through an injection molding process which will be described hereinafter.

In this embodiment, the accommodation portion 130 may accommodate the substrate in which the chip is disposed or to be disposed, and support or fix the accommodated substrate.

Referring to FIG. 3, the accommodation portion 130, which is a space in which the chip is to be mounted, has a bottom surface having a size and a shape corresponding to a bottom surface of the substrate, and has a surface of a wall formed in an empty space having a size and a shape corresponding to a side surface of the substrate.

That is, the substrate may be inserted into the empty space of the accommodation portion 130, and the heat sink 100 may emit the heat generated from the substrate through the heat dissipation portion 140 formed in the opposite direction with respect to the bottom surface of the accommodation portion 130.

In FIG. 3, the bottom surface of the accommodation portion 130 is configured to be flat corresponding to a shape of the substrate according to functional characteristics in which the substrate is inserted into the accommodation portion 130. However, the bottom surface of the accommodation portion 130 may be configured to increase the contact surface area by changing the shapes of the bottom surface and the substrate and the bottom surface of the accommodation portion 130 or by changing it into plug-in form so that the substrate is accommodated well in the accommodation portion 130.

Further, in this embodiment, the accommodation portion 130 may further include a supporting portion 120 as a structure for supporting and fixing the accommodated substrate. Referring to FIG. 3, the supporting portion 120 may be connected to the surface of the wall of the accommodation portion 130 fixing the side surface of the substrate, and be formed to protrude in a shape that covers at least one portion of the upper surface of the substrate. When the LED chip is mounted on the substrate and is operated as an optical device, the supporting portion 120 may preferably have a shape that covers one portion with respect to the upper surface of the substrate, so that an influence on the amount of light emitted from the optical device is minimized.

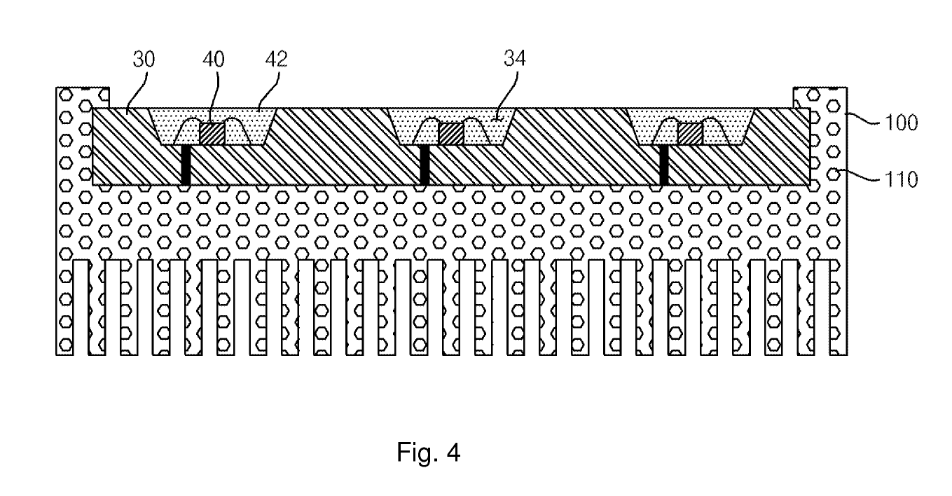

Referring to FIG. 4, the supporting portion 120 of the heat sink 100 containing a heat dissipation material 110 may perform a function of fixing the upper surface of the substrate, and fixing the side surface of the substrate of a side wall of the accommodation portion 130, and the bottom surface of the accommodation portion 130 may support and fix the substrate. As shown in FIG. 2, in order to dissipate heat generated from the optical element 40, and the TIM 10 such as a silicone oil and the like filled with aluminum oxide, zinc oxide, or boron nitride, and the like which has excellent heat dissipation characteristics for bonding the substrate 30 on the heat sink 20, which is formed of a material such as aluminum and the like, may not be further required.

Hereinafter, the heat sink 100 containing a heat dissipation material 110 will be described.

Referring to FIG. 3, the heat dissipation portion 140 of the heat sink 100 may be formed below the accommodation portion 130. The heat dissipation portion 140 may have no influence on the amount of the light emitted from the optical element 40 mounted on the accommodated substrate, and may absorb heat generated from the optical element 40 and emit the absorbed heat to the outside by being formed below the accommodation portion 130. The heat dissipation portion 140 may preferably be formed to have a great surface area to maximize the heat dissipation function. Accordingly, as shown in FIG. 3, the heat dissipation portion 140 may absorb heat generated from the substrate and emit the absorbed heat to the outside by constituting a plurality of nodes having a concave-convex shape. Further, the heat dissipation portion 140 may be a portion of the lighting component, and may be variously designed according to a mold shape. For example, the heat dissipation portion 140 may have various shapes such as an accommodation groove or a bump to connect to or support the lighting component.

More specifically, referring to FIG. 4, in this embodiment, the heat dissipation portion 140 may insulate the accommodated substrate, and emit the heat generated from the substrate or the chip mounted thereon to the outside through the embedded heat dissipation material 110. Insulating the accommodated substrate may mean for preserving the electrical insulative properties of the original substrate electrically isolated by the insulating layer, and also preventing the insulation from deteriorating through the heat dissipation material 110, in FIGS. 1a and 1b described above. Moreover, in order to preserve the electrical insulative properties, in this embodiment, the accommodated substrate may further include a protection portion (not shown) covering the insulating portion to protect the insulating portion exposed in the bottom surface of the substrate, and the protection portion (not shown) may be formed by an epoxy material.

As shown in FIGS. 3 and 4, the heat sink 100 containing a heat dissipation material 110 according to an embodiment of the present invention may be constituted by embedding a material having heat conductivity with respect to an insulating material, for example, a plastic in which injection molding is possible. Accordingly, the heat generated from the substrate or the chip may be emitted to the outside through the embedded heat dissipation material 110.

Accordingly, in this embodiment, an embedded ratio of the heat dissipation material 110 may be related to heat dissipation performance of the heat sink 100, and the embedded ratio of the heat dissipation material 110 may preferably be determined within a range in which the insulation of the substrate is not impaired.

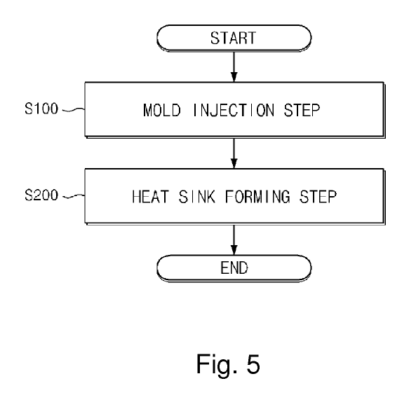

Hereinafter, a method of manufacturing the heat sink 100 will be described with reference to FIG. 5.

Referring to FIG. 5, a method of manufacturing the heat sink 100 containing a heat dissipation material 110 according to an embodiment of the present invention may include a mold injection step (S100), and a heat sink 100 forming step (S200).

In this embodiment, in the mold injection step (S100) an insulating material embedded with the heat dissipation material 110 is injected into a mold capable of forming a space to accommodate the original substrate, wherein the substrates mounted with chips are inserted or chips are mounted thereon. Accordingly, in this embodiment, the mold injection step (S100) may be injecting the insulating material embedded with the heat dissipation material 110 into the mold where a space is formed therein to accommodate the original substrate, wherein the substrates mounted with chips are inserted or chips are mounted thereon.

That is, when the insulating material is injected into the mold in which the substrate is previously inserted, the chip package including the heat sink may be manufactured by the method of manufacturing the heat sink according to an embodiment of the present invention, and when the insulating material is injected into the mold configured to provide the space, the chip package may be manufactured by a process of inserting the chip substrate into the space again after manufacturing the heat sink.

As described above, in this embodiment, since a material such as a plastic which is the injection molding can be used as the heat sink 100, the mold injection step (S100) may include injecting the plastic in a liquid form, in which the heat dissipation material is embedded, into the mold.

In this embodiment, the mold may have a shape for accommodating the substrate, and be formed to have a space for constructing a supporting portion 120 for fixing the upper surface of the substrate, the wall surface of the accommodation portion 130 for fixing the side surface of the substrate, and the bottom surface of the accommodation portion 130 for supporting and fixing the substrate.

Next, the heat sink 100 forming step (S200) may be performed by hardening or curing the insulating material injected in the mold injection step (S100) in order to accommodate the substrate, insulating the accommodation portion 130 for supporting or fixing the accommodated substrate and the accommodated substrate, and manufacturing the heat dissipation portion 140 for dissipating the heat generated from the substrate or the chip mounted on the substrate to the outside through the heat dissipation material 110 in a shape according to the mold.

According to the steps described above, since the heat sink 100 containing a heat dissipation material 110 is manufactured by injection molding, a manufacturing process can be simplified. Specifically, when the insulating material is injected into the mold in which the substrate is previously inserted, the chip package including the heat sink can be manufactured through one injection molding step.

Further, since the heat sink 100 of a single structure is used, the TIM bonding layer for bonding the conventional substrate and the heat sink may not be required, and the insulating layer 22 for electrically insulating between the substrate and the heat sink may not be required. Accordingly, the structure can be simplified.

The above description is only illustrative of embodiments of the spirit of this inventive concept. Those skilled in the art will readily appreciate that many modifications, changes, and alternatives are possible without materially departing from the novel teachings and advantages.

Accordingly, the embodiments and the accompanying drawings disclosed in this specification are not intended to limit the scope of this inventive concept but to describe this inventive concept, and the scope of this inventive concept cannot be limited by the embodiments and the accompanying drawings. The scope of this inventive concept should be construed by the claims, and all spirits within the equivalent scope will be construed as being included in the scope of this inventive concept.

What is claimed is:

1. A heat sink for a chip mounting substrate, which contains a heat dissipation material, comprising:
an accommodation portion configured to accommodate a substrate whereon a chip is mounted or to be mounted, and support or fix the accommodated substrate; and
a heat dissipation portion configured to insulate the accommodated substrate, and dissipate heat generated from the substrate or the chip mounted on the substrate to an outside through a heat dissipation material contained in the heat dissipation portion.

2. The heat sink for the chip mounting substrate according to claim 1, wherein the accommodation portion and the heat dissipation portion are formed by injecting an insulating material containing the heat dissipation material into a mold configured to provide a space for accommodating the substrate.

3. The heat sink for the chip mounting substrate according to claim 1, wherein the accommodation portion comprises:
a supporting portion configured to fix at least one portion of an upper surface of the accommodated substrate;
an accommodation portion wall surface configured to fix a side surface of the substrate; and
an accommodation portion bottom surface configured to support and fix the substrate.

4. The heat sink for the chip mounting substrate according to claim 1, wherein the heat sink is configured to preserve electrical insulative properties of an original substrate electrically isolated by an insulating layer in the substrate.

5. The heat sink for the chip mounting substrate according to claim 1, wherein a ratio of the heat dissipation material contained in the heat sink is determined based on a thermal conductivity of the heat dissipation material and an electrical insulation so as to preserve electrical insulative properties of an original substrate electrically isolated by an insulating layer in the substrate.

6. A method of manufacturing a heat sink for a chip mounting substrate containing a heat dissipation material, comprising:
injecting an insulating material containing the heat dissipation material into a mold configured to provide a space for accommodating a substrate whereon a chip is mounted or to be mounted; and
forming an accommodation portion and a heat dissipation portion by hardening and curing the injected insulating material, wherein an accommodation portion is configured to accommodate the substrate and support or fix the accommodated substrate, and a heat dissipation portion is configured to insulate the accommodated substrate and dissipate heat generated from the substrate or the chip mounted thereon to an outside through the heat dissipation material.

7. The method of manufacturing the heat sink for the chip mounting substrate according to claim 6, wherein the mold comprises a space for forming a supporting portion configured to fix at least one portion of an upper surface of the inserted or accommodated substrate, an accommodation portion wall surface configured to fix a side surface of the substrate, and an accommodation portion bottom surface configured to support and fix the substrate.

8. The method of manufacturing the heat sink for the chip mounting substrate according to claim 6, wherein a ratio of the heat dissipation material contained in the heat sink is determined based on a thermal conductivity of the heat dissipation material and an electrical insulation so as to preserve electrical insulative properties of an original substrate electrically isolated by an insulating layer in the substrate.
